(19) United States
(12) Patent Application Publication
(10) Pub. No.: US 2015/0211330 A1
(43) Pub. Date: Jul. 30, 2015

(54) Methods for Maintaining Zonal Isolation in A Subterranean Well

(71) Applicant: Schlumberger Technology Corporation, Sugar Land, TX (US)

(72) Inventors: Fatma Daou, Rio de Janeiro (BR); Craig Borman, Camrose (CA); Bernard Piot, Paris (FR)

(21) Appl. No.: 14/421,995

(22) PCT Filed: Sep. 2, 2013
(86) PCT No.: PCT/US2013/057762

§ 371 Date: Feb. 16, 2015

(51) Int. Cl. E21B 33/14; C09K 8/42

(52) U.S. Cl. CPC E21B 33/14; C09K 8/42

(57) ABSTRACT

A cement for use in wells in which carbon dioxide is injected, stored or extracted, comprises elastomer particles. In the event of cement-matrix failure, or bonding failure between the cement/casing interface or the cement/borehole-wall interface, the elastomer particles swell when contacted by carbon dioxide. The swelling seals voids in the cement matrix, or along the bonding interfaces, thereby restoring zonal isolation.

### BACKGROUND

The statements in this section merely provide background information related to the present disclosure and may not constitute prior art.

This disclosure relates to compositions and methods for treating subterranean formations, in particular, compositions and methods for cementing and completing wells into which carbon dioxide is injected, stored or extracted.

During the construction of subterranean wells, it is common, during and after drilling, to place a tubular body in the wellbore. The tubular body may comprise drillpipe, casing, liner, coiled tubing or combinations thereof. The purpose of the tubular body is to act as a conduit through which desirable fluids from the well may travel and be collected. The tubular body is normally secured in the well by a cement sheath. The cement sheath provides mechanical support and hydraulic isolation between the zones or layers that the well penetrates. The latter function is important because it prevents hydraulic communication between zones that may result in contamination. For example, the cement sheath blocks fluids from oil or gas zones from entering the water table and polluting drinking water. In addition, to optimize a well's production efficiency, it may be desirable to isolate, for example, a gas-producing zone from an oil-producing zone.

The cement sheath achieves hydraulic isolation because of its low permeability. In addition, intimate bonding between the cement sheath and both the tubular body and borehole is necessary to prevent leaks. However, over time the cement sheath can deteriorate and become permeable. Alternatively, the bonding between the cement sheath and the tubular body or borehole may become compromised. The principal causes of deterioration and debonding include physical stresses associated with tectonic movements, temperature changes and chemical deterioration of the cement.

These being particularly applicable to wells into which carbon dioxide is injected (e.g. during Enhanced Oil Recovery technique), in which carbon dioxide is stored or from which carbon dioxide is recovered. In addition, there are some oil and gas wells whose reservoirs naturally contain carbon dioxide.

A relatively new category of wells involving carbon dioxide is associated with carbon-sequestration projects. Carbon sequestration is a geo-engineering technique for the long-term storage of carbon dioxide or other forms of carbon, for various purposes such as the mitigation of “global warming”. Carbon dioxide may be captured as a pure byproduct in processes related to petroleum refining or from the flue gases from power plants that employ fossil fuels. The gas is then usually injected into subsurface saline aquifers or depleted oil and gas reservoirs. One of the challenges is to trap the carbon dioxide and prevent leakage back to the surface; maintaining a competent and impermeable cement sheath is a critical requirement.

The previously disclosed cement systems are concerned with traditional wells and swell when contacted by water and/or hydrocarbons; none of these aims at behavior of the cement sheath when contacted by carbon dioxide.

### SUMMARY

The present disclosure presents improvements by describing compositions that form a sustainable cement sheath in a carbon-dioxide environment, and methods by which they may be prepared and applied in subterranean wells.

In an aspect, embodiments relate to methods for maintaining zonal isolation in a subterranean well into which carbon dioxide is injected, stored, extracted or naturally present. A tubular body is installed inside the borehole of a well, or inside a previously installed tubular body. An aqueous cement slurry, containing a material that swells when contacted by carbon dioxide, is pumped into the borehole. The cement slurry is allowed to set and harden. In the event of cement-matrix or bonding failure, the set cement is exposed to wellbore fluids that contain carbon dioxide. The material is allowed to swell, thereby restoring zonal isolation.

In a further aspect, embodiments relate to methods for cementing a subterranean well having a borehole, in which carbon dioxide is injected, stored, extracted or naturally present. A tubular body is installed inside the borehole of a well, or inside a previously installed tubular body. An aqueous cement slurry, containing a material that swells when contacted by carbon dioxide, is pumped into the borehole. The cement slurry is allowed to set and harden.

In yet a further aspect, embodiments relate to methods for completing a subterranean well having a borehole, in which carbon dioxide is injected, stored, extracted or naturally present. A tubular body is installed inside the borehole of a well, or inside a previously installed tubular body. An aqueous cement slurry, containing a material that swells when contacted by carbon dioxide, is pumped into the borehole. The cement slurry is allowed to set and harden.

### BRIEF DESCRIPTION OF THE DRAWINGS

FIG. 1 shows the swelling behavior of VITON™ elastomer particles in the presence of nitrogen.

FIG. 2 shows the swelling behavior of VITON™ elastomer particles in the presence of carbon dioxide.

FIG. 3 shows the swelling behavior of AFLAS™ elastomer particles in the presence of nitrogen.

FIG. 4 shows the swelling behavior of AFLAS™ elastomer particles in the presence of carbon dioxide.

FIG. 5 shows the swelling behavior of acrylonitrile-butadiene rubber particles in the presence of carbon dioxide.

FIG. 6 shows the swelling behavior of acrylic rubber particles in the presence of carbon dioxide.

FIG. 7 shows the swelling behavior of silicone rubber particles in the presence of carbon dioxide.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that the Applicant appreciate and understands that any and all data points within the range are to be considered to have been specified, and that the Applicant possessed knowledge of the entire range and all points within the range.

As stated earlier, cement systems that form durable cement sheath in an environment containing carbon dioxide would be positively received by the industry. The inventors have determine that cement composition comprising materials that swell in the presence of carbon dioxide would respond to the industry challenges as such carbon dioxide swellable compounds will enable the cement sheat to close its own voids and/or cracks that may appear.

The carbon dioxide may be wet, dry, supercritical or dissolved in an aqueous medium. By naturally present, it has to be understood that the carbon dioxide is present in the borehole at a minimum concentration of 5 moles per liter of fluid.

The Applicant has determined that certain elastomers may fulfill the required swellable capacity in the presence of carbon dioxide. The elastomers comprise chlorofluorocarbons, tetrafluoroethylene-propylene copolymers, ethylene-propylene copolymers, acrylonitrile-butadiene rubbers, acrylic rubbers, silicone rubbers, isobutene-isoprene rubbers, nitrile rubbers, hydrogenated nitrile butadiene rubbers, tetrafluoroethylene-perfluorovinyl methyl ether copolymers and combinations thereof.

In an aspect, embodiments relate to methods for maintaining zonal isolation in a subterranean well having a borehole, into which carbon dioxide is injected, stored, extracted or naturally present. A tubular body is installed inside the borehole of a well, or inside a previously installed tubular body. An aqueous cement slurry, containing a material that swells when contacted by carbon dioxide, is pumped into the borehole. The cement slurry is allowed to set and harden. In the event of cement-matrix or bonding failure, the set cement is exposed to wellbore fluids that contain carbon dioxide. The material is allowed to swell, thereby restoring zonal isolation.

In a further aspect, embodiments relate to methods for cementing a subterranean well having a borehole, in which carbon dioxide is injected, stored, extracted or naturally present. A tubular body is installed inside the borehole of a well, or inside a previously installed tubular body. An aqueous cement slurry, containing a material that swells when contacted by carbon dioxide, is pumped into the borehole. The cement slurry is allowed to set and harden.

In yet a further aspect, embodiments relate to methods for completing a subterranean well having a borehole, in which carbon dioxide is injected, stored, extracted or naturally present. A tubular body is installed inside the borehole of a well, or inside a previously installed tubular body. An aqueous cement slurry, containing a material that swells when contacted by carbon dioxide, is pumped into the borehole. The cement slurry is allowed to set and harden.

For all aspects of the invention, the material may be an elastomer comprising chlorofluorocarbons, tetrafluoroethylene-propylene copolymers, ethylene-propylene copolymers, acrylonitrile-butadiene rubbers, acrylic rubbers, silicone rubbers, isobutene-isoprene rubbers, nitrile rubbers, hydrogenated nitrile butadiene rubbers, tetrafluoroethylene-perfluorovinyl methyl ether copolymers and combinations thereof. The concentration of the material may be between about 5% and 50% by volume of solids in the cement slurry, also known as “by volume of blend (BVOB).” Or the range may be between about 10% and 40% BVOB. For optimal performance, the particle-size distribution of the material may be such that the average particle size is between about 10 μm and about 1000 μm. The average particle size may also be between about 100 μm and 900 μm.

Persons skilled in the art will recognize that the present use of elastomers is different and distinct from their use as cement extenders (i.e., to reduce the amount of cement or to reduce the cement-slurry density) or as materials to improve cement flexibility.

For all aspects of the invention the cement may additionally comprise one or more members of the list comprising Portland cement, calcium aluminate cement, fly ash, blast furnace slag, lime-silica blends, zeolites, geopolymers, Sorel cements or chemically bonded phosphate ceramics, and mixtures thereof. The composition shall be pumpable Those skilled in the art will recognize that a pumpable fluid in the context of well cementing has a viscosity lower than about 1000 mPa-s at a shear rate of 100 s⁻¹ at the temperatures to which the fluid is exposed during a cementing operation, and during the time necessary to place the composition in the well. Also, the tubular body may comprise one or more members of the list comprising drillpipe, casing, liner and coiled tubing. In addition, the borehole may penetrate at least one fluid-containing reservoir, the reservoir preferably containing fluid with a carbon dioxide concentration greater than about five moles per liter.

The cement slurry may further comprise dispersing agents, fluid-loss-control agents, set retarders, set accelerators, foaming agents, gas generating agents, antifoaming agents, extenders, weighting agents, lost-circulation control agents and combinations thereof. Other compounds may also be present such as coal, petroleum coke, graphite or gilsonite and mixtures thereof Futher, the carbon dioxide swellable elastomers may be coupled to water super absorbent polymers such as those described in EP 1623089 incorporated herein in its entirety. A further association may be with one or more compounds from the list comprising an aqueous inverse emulsion of polymer comprising a betaine group, poly-2,2,1-bicyclo heptene (polynorbornene), alkylstyrene, crosslinked substituted vinyl acrylate copolymers, diatomaceous earth, natural rubber, vulcanized rubber, polyisoprene rubber, vinyl acetate rubber, polychloroprene rubber, hydrogenated acrylonitrile butadiene rubber, ethylene propylene diene monomer, ethylene propylene monomer rubber, styrene-butadiene rubber, styrene/propylene/diene monomer, brominated poly(isobutylene-co-4-methylstyrene), butyl rubber, chlorosulphonated polyethylenes, polyacrylate rubber, polyurethane, brominated butyl rubber, chlorinated butyl rubber, chlorinated polyethylene, epichlorohydrin ethylene oxide copolymer, ethylene acrylate rubber, ethylene propylene diene terpolymer rubber, sulphonated polyethylene, fluoro silicone rubbers, fluoroelastomers, substituted styrene acrylate copolymers and bivalent cationic compounds or any other particles such as those described in WO2004/101951 that swells when exposed to liquid hydrocarbons, the international application being incorporated herein by reference in its entirety. Further combinations may be made with thermoplastic block polymers including for example styrene-isoprene-styrene (SIS), styrene-butadiene-styrene (SBS) and mixtures thereof.

Persons skilled in the art will recognize that these methods may be performed during a primary cementing operation or a remedial cementing operation. The primary cementing operation may be performed the traditional way (i.e., the slurry is pumped down the casing and up the annulus) or by “reverse cementing,” which consists of pumping the slurry down the annulus. Persons skilled in the art will also recognize that the process of carbon dioxide injection may be a remedial treatment to cause the elastomers to swell and restore zonal isolation. In this context, carbon dioxide is injected in the borehole in order to contact the deficient cement sheath thus triggering the self-reparation of it by itself.

### EXAMPLES

The following examples serve to further illustrate the disclosure. The following testing procedure was used for all examples.

Several particles of a test elastomer were placed inside a pressure cell equipped with a window that allows one to observe the behavior of materials within the cell. The cell supplier is Temco Inc., located in Houston, Tex. USA. The cell temperature is also adjustable. A camera captures images from inside the pressure cell, and image-analysis software is employed to interpret the behavior of materials inside the cell. After the elastomer particles were introduced into the cell, the cell was sealed. Either nitrogen or carbon dioxide gas was then introduced into the cell at 1000 psi (6.9 MPa), and the camera recorded the sizes of the particles during exposure periods up to 25 hours at 21° C. (70° F.).

### Example 1

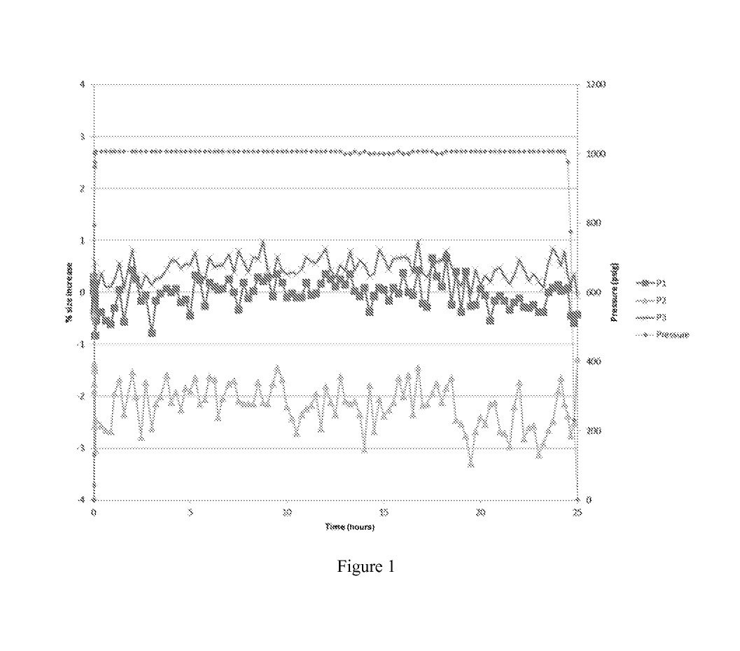

An O-ring made from a chlorofluorocarbon elastomer (VITON™, available from Parker Seals) was ground into pieces that were about 200 μm in size. Three particles (P1, P2 and P3) were placed into the pressure cell, and nitrogen was pumped into the cell until the pressure reached 1000 psi (6.9 MPa). During the testing period, the size of the VITON™ particles was periodically monitored. The results, shown in FIG. 1, reveal little change in the size of the particles during the test period.

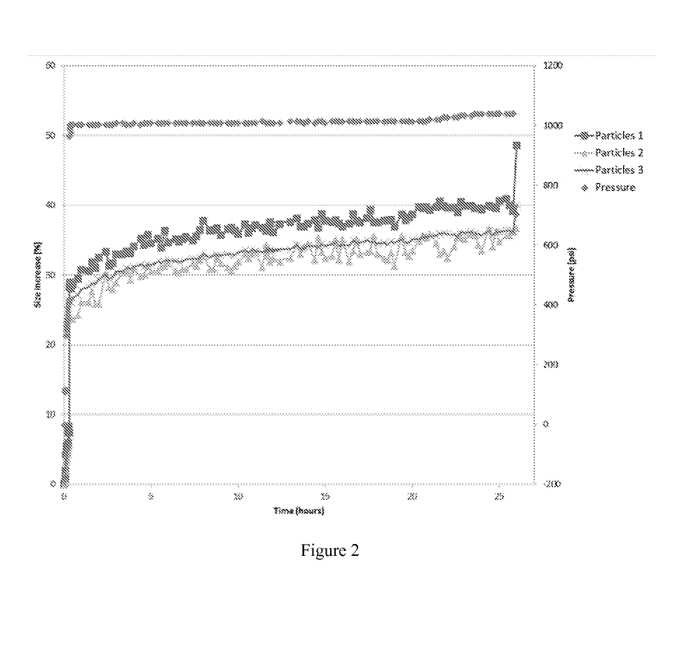

Then, the three VITON™ particles were exposed to carbon dioxide at about 1000 psi (6.9 MPa) and 21° C. As shown in FIG. 2, the particles swelled by about 35-48 vol % during the test period.

### Example 2

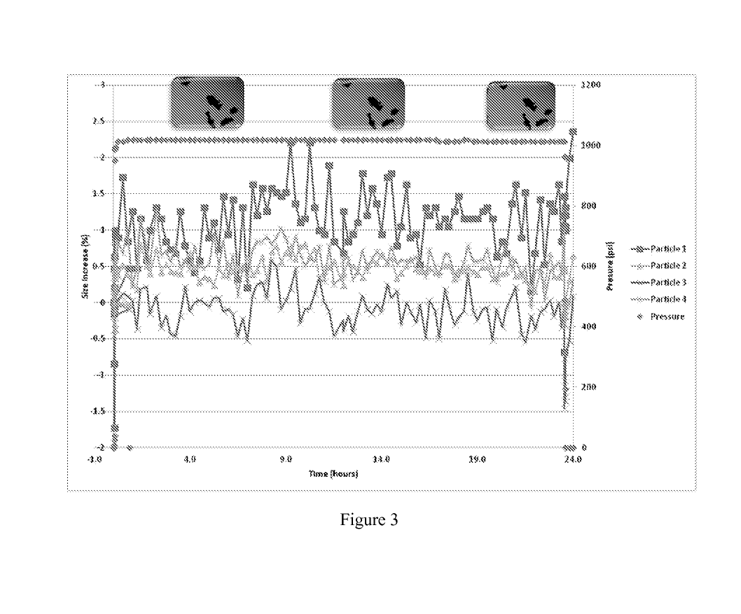

An O-ring made from a fluoroelastomer (AFLAS™, available from Seals Eastern) was ground into pieces that were about 200 μm in size. Four particles (Particles 1, 2, 3 and 4) were placed into the pressure cell, and nitrogen was pumped into the cell until the pressure reached 1000 psi (6.9 MPa). During the testing period, the size of the AFLAS™ particles was periodically monitored. The results, shown in FIG. 3, reveal little change in the size of the particles during the test period.

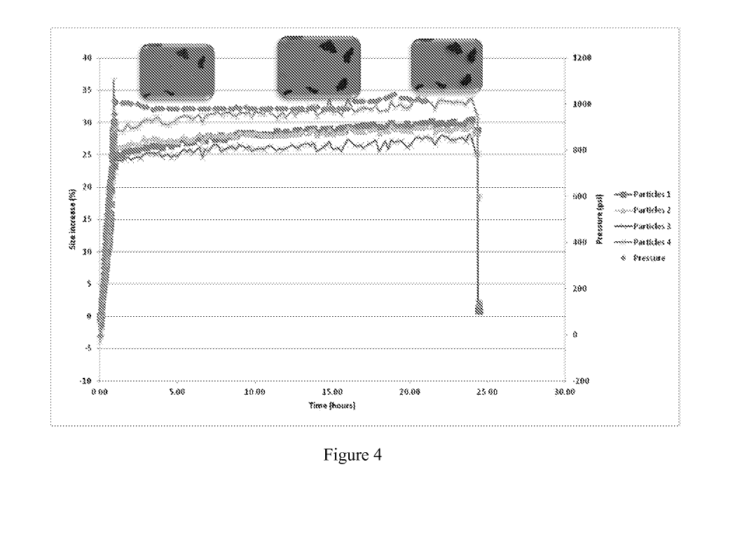

Then, the four AFLAS™ particles were exposed to carbon dioxide at about 1000 psi (6.9 MPa) and 21° C. As shown in FIG. 4, the particles swelled by about 25-37 vol % during the test period.

### Example 3

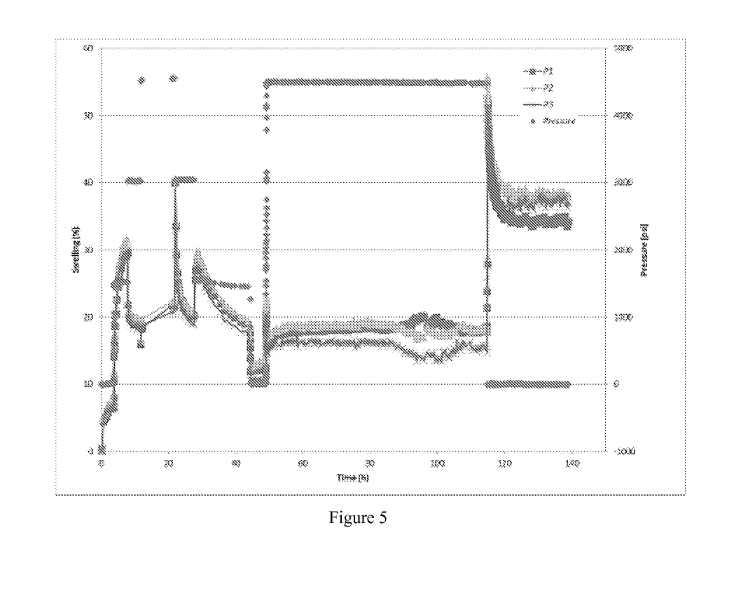

A sample of nitrile butadiene rubber (acrylonitrile-butadiene rubber, available from Eliokem) was ground into pieces that were about 200 μm in size. Three particles (Particles 1, 2 and 3) were placed into the pressure cell, and carbon dioxide was pumped into the cell at pressures up to 4500 psi (31.1 MPa). FIG. 5 shows that, depending on the pressure, the particles swelled by about 20% to 40% during the testing period. In addition, the swelling persisted when the pressure was relieved after about 43 hours exposure.

### Example 4

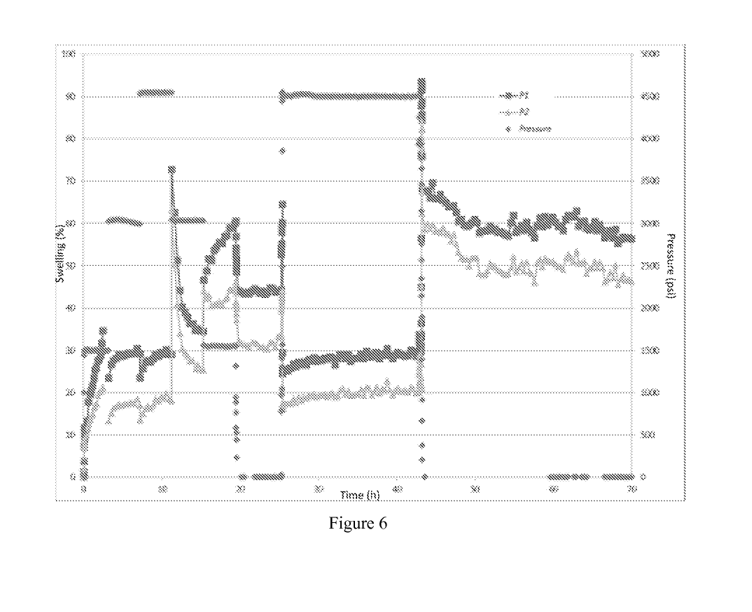

A sample of acrylic rubber (Hytemp™, available from Zeon Chemicals L.P.) was ground into pieces that were about 200 μm in size. Two particles (Particles 1 and 2) were placed into the pressure cell, and carbon dioxide was pumped into the cell at pressures up to 4500 psi (31.1 MPa). FIG. 6 shows that, depending on the pressure, the particles swelled by about 20-30% to about 50-60% during the testing period. In addition, the swelling persisted when the pressure was relieved after about 43 hours exposure.

### Example 5

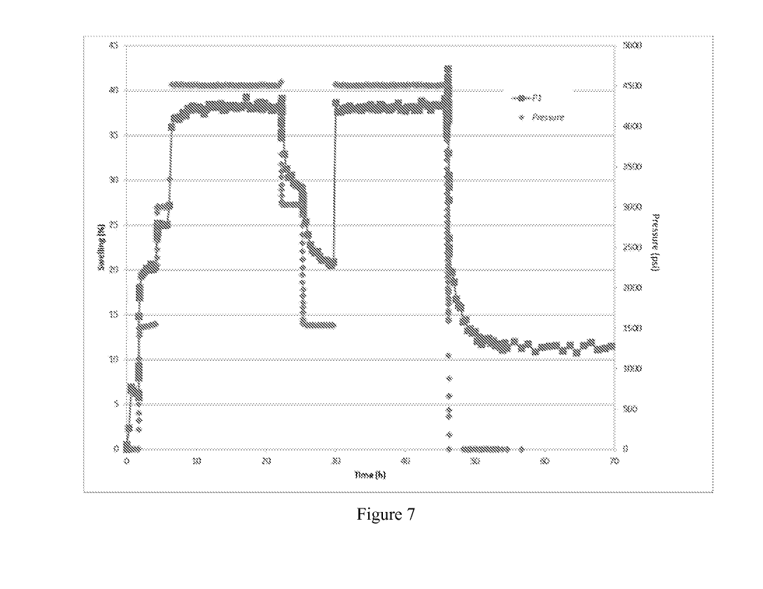

A sample of silicone rubber (VMQ S0604-70, available from Parker Seals) was ground into pieces that were about 200 μm in size. A particle (Particle 1) was placed into the pressure cell, and carbon dioxide was pumped into the cell at pressures up to 4500 psi (31.1 MPa). FIG. 7 shows that, depending on the pressure, the particles swelled by about 10% to 40% during the testing period. In addition, about 10% swelling persisted when the pressure was relieved after about 46 hours exposure.

Although various embodiments have been described with respect to enabling disclosures, it is to be understood that the preceding information is not limited to the disclosed embodiments. Variations and modifications that would occur to one of skill in the art upon reading the specification are also within the scope of the disclosure, which is defined in the appended claims.

1. A method for maintaining zonal isolation in a subterranean well having a borehole in which carbon dioxide is injected, stored, extracted or naturally present, comprising:
(i) installing a tubular body inside the borehole of the well, or inside a previously installed tubular body;
(ii) pumping aqueous cement slurry comprising a material that swells when contacted by carbon dioxide into the borehole;
(iii) allowing the cement slurry to set and harden;
(iv) in the event of cement-matrix or bonding failure, exposing the set cement to wellbore fluids that contain carbon dioxide; and
(v) allowing the material to swell, thereby restoring zonal isolation.

2. The method of claim 1, wherein the material comprises an elastomer comprising chlorofluorocarbons, tetrafluoroethylene-propylene copolymers, ethylene-propylene copolymers, acrylonitrile-butadiene rubbers, acrylic rubbers, silicone rubbers, isobutene-isoprene rubbers, nitrile rubbers, hydrogenated nitrile butadiene rubbers, tetrafluoroethylene-perfluorovinyl methyl ether copolymers and combinations thereof.

3. The method of claim 1, wherein the concentration of the material in the cement slurry is between about 5 percent and about 50 percent by volume of solid blend (BVOB).

4. The method of claim 1, wherein the average particle size of the material is between about 10 μm and about 1000 μm.

5. The method of claim 1, wherein the carbon dioxide is supercritical, wet, dry or dissolved in an aqueous medium.

6. The method of claim 1, wherein the borehole penetrates at least one fluid-containing reservoir, the reservoir containing fluid with a carbon dioxide concentration greater than about five moles per liter.

7. The method of claim 1, wherein the injection of carbon dioxide into the well is performed as a remedial treatment to restore zonal isolation.

8. The method of claim 1, wherein the cement comprises one or more members of the list comprising Portland cement, calcium aluminate cement, fly ash, blast furnace slag, lime-silica blends, zeolites, geopolymers, Sorel cements and chemically bonded phosphate ceramics.

9. The method of claim 1, wherein the cement slurry further comprises dispersing agents, fluid-loss-control agents, set retarders, set accelerators, foaming agents, gas generating agents, antifoaming agents, extenders, weighting agents, lost-circulation control agents and combinations thereof.

10. The method of claim 1, wherein the tubular body comprises one or more members of the list comprising drillpipe, casing, liner and coiled tubing.

11. A method for cementing a subterranean well having a borehole in which carbon dioxide is injected, stored, extracted or naturally present, comprising:
(i) installing a tubular body inside the borehole of the well, or inside a previously installed tubular body;
(ii) pumping aqueous cement slurry comprising a material that swells when contacted by carbon dioxide into the borehole; and
(iii) allowing the cement slurry to set and harden inside the annular region.

12. The method of claim 11, wherein the material comprises an elastomer comprising chlorofluorocarbons, tetrafluoroethylene-propylene copolymers, ethylene-propylene copolymers, acrylonitrile-butadiene rubbers, acrylic rubbers, silicone rubbers, isobutene-isoprene rubbers, nitrile rubbers, hydrogenated nitrile butadiene rubbers, tetrafluoroethylene-perfluorovinyl methyl ether copolymers and combinations thereof.

13. The method of claim 11, wherein the concentration of the material in the cement slurry is between about 5 percent and about 50 percent by volume of solid blend (BVOB).

14. The method of claim 11, wherein the average particle size of the material is between about 10 μm and about 1000 μm.

15. The method of claim 11, wherein the carbon dioxide is supercritical, wet, dry or dissolved in an aqueous medium.

16. The method of claim 11, wherein the borehole penetrates at least one fluid-containing reservoir, the reservoir containing fluid with a carbon dioxide concentration greater than about five moles per liter.

17. The method of claim 11, wherein the injection of carbon dioxide into the well is performed as a remedial treatment to restore zonal isolation.

18. The method of claim 11, wherein the cement comprises one or more members of the list comprising Portland cement, calcium aluminate cement, fly ash, blast furnace slag, lime-silica blends, zeolites, geopolymers, Sorel cements and chemically bonded phosphate ceramics.

19. The method of claim 11, wherein the cement slurry further comprises dispersing agents, fluid-loss-control agents, set retarders, set accelerators, foaming agents, gas generating agents, antifoaming agents, extenders, weighting agents, lost-circulation control agents and combinations thereof.

20. The method of claim 11, wherein the tubular body comprises one or more members of the list comprising drillpipe, casing, liner and coiled tubing.
